(19) United States
(12) Patent Application Publication
(10) Pub. No.: US 2016/0201695 A1
(43) Pub. Date: Jul. 14, 2016

(54) VALVE COMPONENTS

(71) Applicant: HYDAC TECHNOLOGY GMBH, Sulzbach/Saar (DE)

(72) Inventor: Sascha Alexander BIWERSI, Mettlach (DE)

(21) Appl. No.: 14/912,419

(22) PCT Filed: Sep. 2, 2014
(86) PCT No.: PCT/EP2014/002382

§ 371 Date: Feb. 17, 2016

(30) Foreign Application Priority Data
Sep. 3, 2013 (DE) 10 2013 014 671.2

(51) Int. Cl. F15B 13/02; F15B 13/04

(52) U.S. Cl. CPC F15B 13/026; F15B 13/0417; F15B 13/0402

(57) ABSTRACT

The invention relates to a first valve component (10), in particular a pressure compensator-type component, comprising a valve slide (16) that can be guided in a valve housing (12) in a longitudinal direction, said valve slide having a control part (34) for Controlling a fluid-conducting connection (28) between at least two fluid connection points (30, 32) accommodated in the valve housing (12). Said control part has at least one pocket-like recess (38), at least part of which is bordered by a fluid-guiding surface (40) running at least between two vertices of the recess and running with increasing inclination from one vertex to another vertex. The first valve component is characterised in that, starting from a predeterminable distance before the other vertex, the fluid-guiding surface (40) runs from its point of greatest inclination with decreasing inclination in the direction of said other vertex. The invention also relates to two further valve components.

The invention relates to a first valve component, conceived in particular as a pressure maintenance-type component, having a valve slide which is movably guided in a valve housing in a longitudinal direction and which has a control part for controlling a fluid-conducting connection between at least two fluid connection points accommodated in the valve housing, said control part having at least one pocket-like recess, at last part of which is bordered by a fluid-guiding surface running at least between two vertices of the recess and having a slope that increases from one vertex to the other vertex.

The invention further relates to a second valve component, conceived in particular as a pressure maintenance-type component, having a valve slide, which is movably guided in a valve housing in a longitudinal direction and which has two control parts for controlling a fluid-conducting connection between at least two fluid connection points accommodated in the valve housing, of which at least one control part has at least one pocket-like recess, wherein the other control part in the non-actuated state is, by means of a guide part, in contact with an inner wall of the housing along which the valve slide is movably guided.

Lastly, the invention relates to a third valve component, conceived in particular as a pressure maintenance-type component, having a valve slide which is movably guided in a valve housing in a longitudinal direction and which has a first control part and a second control part for controlling a fluid-conducting connection between at least two fluid connection points accommodated in the valve housing, wherein the second control part is, by means of a guide part, in contact with an inner wall of the housing along which the valve slide is movably guided, wherein the valve slide is guided by means of another guide part through the inner wall of the valve housing in the region of the connection point serving as the fluid outlet therein, and wherein a fluid guide is arranged between the first and second control parts, which holds these control parts apart.

Such pressure maintenance-type components are known to the prior art in diverse forms of embodiment, in particular as integral components of directional control valves. For example, EP 1 500 825 A2 discloses a pressure maintenance valve with a valve slide which is movably guided in a longitudinal direction in a valve housing and which has a control part for controlling a fluid-conducting connection between at least two fluid connection points accommodated in the valve housing, which control part has at least one pocket-like recess, at least part of which is bordered by a fluid-guiding surface running between at least two vertices of the recess and running with an initially increasing and then constant slope from one vertex to the other vertex, wherein the other vertex, which is arranged at the exit of the pocket-like recess, borders the edge or corner point of a right angle as a transition between the fluid-guiding surface and a collar surface of the valve slide or control slide, the collar surface extending perpendicular to the fluid-guiding surface.

The disadvantage with such pressure maintenance valves arises in that starting from the zero stroke, the progression of the active standard cross section increases quite abruptly over the opening stroke and has at least one kink in the further progression. Due to this progression of the standard cross section over the opening stroke, the control accuracy and the stability of the prior art pressure maintenance valves need improvement in order to increase the precision of the fluid control.

Because the prior art directional control valves with upstream or downstream pressure maintenance components must frequently fulfill a so-called load-holding function, of which the geometric configuration is typically embodied by a circumferential vertical edge, effective compensation of the flow forces is thus complicated.

On the basis of the prior art, the invention addresses the problem of illustrating at least one valve component with improved control accuracy and increased stability that responds swiftly.

This problem is solved by a first valve component having the features of claim 1. Advantageous embodiments of this valve component emerge from dependent claims 2 through 6.

Another solution to the problem comprises a second valve component having the features of claim 7. An advantageous embodiment of this valve component arises from claim 8.

Lastly, a solution to the problem comprises a third valve component with the features of claim 9. Advantageous embodiments of this valve component arise from claims 10 and 11.

The first valve component is characterized in that, starting from a predeterminable distance from the other vertex, the fluid-guiding surface runs from its point of greatest slope with decreasing slope toward the other vertex.

In this manner the pocket-like recess does not open at an edge, but transitions smoothly into a collar-like front surface (adjacent to the recess) of the control part as a component of the valve slide. The advantage of this is that the standard cross section does not change abruptly (as in the prior art) at an edge. The progression of the standard cross section over the opening stroke therefore does not have a kink, but instead, a continuous, monotonically increasing cross section with a very shallow initial slope is achieved over the opening stroke of the valve slide with its control part such that, in particular at the beginning of the opening process, a very high control accuracy prevails even over a relatively long opening stroke of the valve slide. Consequently, the control accuracy is considerably higher than with prior art solutions and the stability of the control is likewise improved.

Preference is given, however, to the fluid-guiding surface having a continuous progression and a minimal incline or slope, preferably assuming the value of zero, at the respective other vertex. With a reverse arrangement of the vertices, however, there is the possibility of starting with the shallow slope at the bottom of the pocket and letting the fluid-guiding surface extend outwardly with increasing slope to the control collar. Particular preference is given to the fluid-guiding surface having a curved (S-shape) configuration and to the various gradients between the vertices being formed by the transition from a concave to a convex curve progression. In principle, however, it is also conceivable for the curve progression to be formed by other arc shapes, in particular semicircles. Such a rounded guiding surface also contributes to a continuous, “kink-free” control performance of the valve component. In particular, two adjacent fluid-guiding surfaces, which each merge into one another at the bottom of the pocket, form the boundary edge for this pocket.

In principle, however, it is also conceivable for the respective fluid-guiding surface to be formed by a plurality of sequentially arranged, planar surface sections, wherein each surface section preferably has a uniform slope that corresponds to the slope of the curve progression of the fluid-guiding surface in a middle area of the respective surface section. According to a development, the progression of the fluid-guiding surface can also be approximated iteratively by step-like subsections, wherein the surfaces of the steps can be oriented coaxially or transversely to the longitudinal axis of the valve slide.

Advantageously, a plurality of pocket-like recesses can be arranged along the outer periphery of the control part of the valve slide such that the fluid-guiding surfaces between the individual vertices form a closed sine or cosine curve progression along this outer periphery. The progression of the guiding surfaces is correspondingly wave-shaped. The individual recesses merge into one another without any gap.

Advantageously, a groove-like recess connects to the bottom of a pocket-like recesses in the region of a vertex, at least in a portion of the pocket-like recesses. These groove-like recesses offer the possibility of carrying out a fine-tuned control for the fluid volumes being conducted.

The largest opening cross section of the respective pocket-like recesses is oriented to the fluid connection point that serves as the fluid outlet of the valve housing. In this manner the standard cross section can be continuously adapted to the increasing amounts of fluid as the opening stroke of the valve slide increases.

The second valve component is characterized in that the guide part has a switching edge surface extending in a step-like manner that faces the control part.

In this manner, a defined trailing edge is formed, at which the flow surface transitions from an annular transverse surface extending in the radial plane at an edge, into an outer peripheral surface extending coaxially to the longitudinal axis of the valve slide. An improvement of the sealing function inside the second valve component is achieved by the switching edge surface extending in a step-like manner. With the valve component of the invention, a load-holding function is achievable for a pressure maintenance component or valve with simultaneous flow force compensation, which occurs in the case if the trailing edge is both a flow guide (in particular in the shape of a flow cone) and a defined vertical edge.

The switching edge surface extending in a step-like manner in the guide part of the second control part can be formed by a reduction in diameter between the outer peripheral side of the guide part and a preferably conically extending transition part of the valve slide in the direction of the first control part. A flow guide serving as a flow force compensation means is formed by the conically extending transition part.

The third valve component is characterized in that another fluid guide is present, which holds the second control part away from the second guide part.

Such a groove advantageously improves the flow dynamics of the second control part and facilitates the retraction of the valve slide. In addition, the sealing gap between the first guide part and the inner wall of the housing is reduced, which favors the load holding function of the previously described second valve component.

The two fluid guides, which form axial spacings between the first control part and the second guide part as well as between the second control part and the second guide part, are obtained by groove-like, circumferential reductions in diameter in the valve slide. These reductions in diameter give rise to a wide, free, annular cross section through which the fluid can flow with minor pressure losses, which, due to low mass, likewise favors rapid control performance.

The valve slide can rest with one of its free front surfaces against an energy storage unit and can abut with its other free face against a volume space of variable volume, into which an inner channel of the valve slide opens with one of its ends, its other end being fluidically connected to the fluid guide between the two control parts. In this manner, the fluid pressure at the fluid inlet can be efficiently reproduced on the other free front surface. Additional difficult-to-drill boreholes in the valve housing are not needed.

It is possible to combine a non-return function and a flow force compensation because the distance between the respective control edge and the trailing edge is sufficiently large; if this were not the case, a reasonably large stroke resolution of the control edge could not be combined with an effective flow force compensation.

The invention is explained in more detail with reference to an exemplary embodiment illustrated in the figures. Shown are:

FIG. 1 a longitudinal section through a part of a valve, in particular a pressure maintenance valve, with three valve components constructed differently according to the invention;

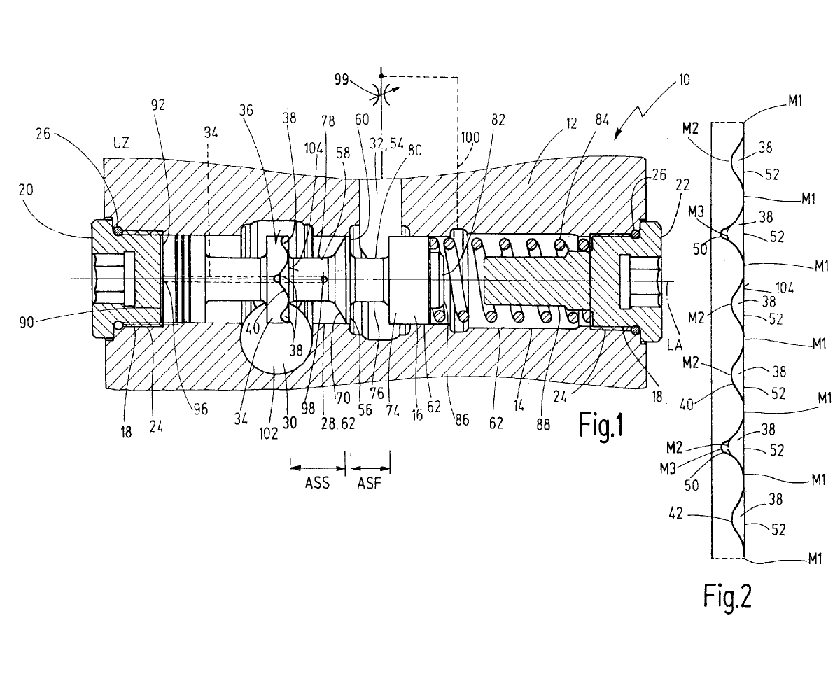

FIG. 2 a view of an unwound illustration of the outer periphery of the first control part;

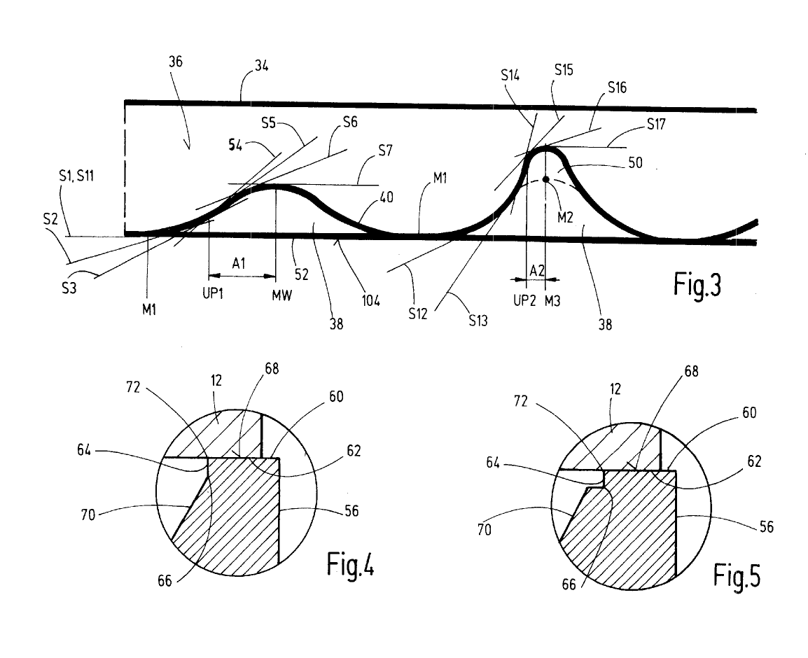

FIG. 3 a figurative illustration of a magnified section from FIG. 2;

FIGS. 4 and 5 two detailed illustrations of the switching edge extension of the second control part; and

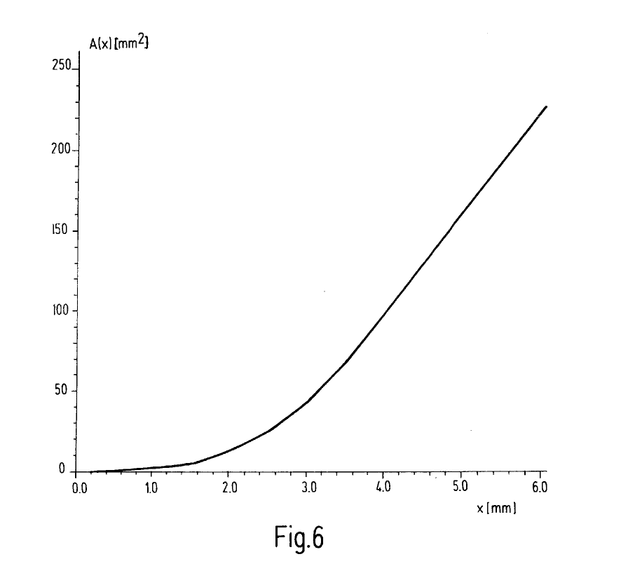

FIG. 6 a graph plotting the progression of the standard cross section over the opening stroke of the valve slide for the first control part thereof.

A part of a valve structure 10, in particular a pressure maintenance valve structure, is illustrated in FIG. 1. A valve housing 12 has a valve bore 14, in which a valve slide 16 is arranged that is movably guided in a longitudinal direction. The valve bore 14 is closed at both ends 18 by cap screws 20, 22, which each engage in an allocatable female thread 24 of the valve bore 14. Provision is made of annular sealing elements 26 between each of the cap screws 20, 22 and the valve housing 12.

The valve slide 16 is provided for controlling a fluid-conducting connection 28 between at least two fluid connection points 30, 32 accommodated in the valve housing 12. The valve slide 16 has a cylindrical first control part 34, which has pocket-like recesses 38 on the outer periphery 36 (also see FIG. 2 and FIG. 3), which run coaxially to the longitudinal axis LA of the valve slide 16 and which are bordered by circumferential fluid-guiding surfaces 40, which each extend between vertices (maxima or minima) M1, M2, M3 of the recess 38 and which each run from one vertex M1; M2, M3 towards the other vertex M2, M3; M1 with an increasing incline or, respectively, with an increasing slope (slope S1=0<slope S2<slope S3<slope S4, or slope S11=0<slope S12<slope S13<slope S14).

According to the invention, provision is made such that, starting at a predeterminable distance A1; A2 from the other vertex M2, M3; M1, the fluid-guiding surface 40 runs from its point of greatest slope S4; S14 at reversal points UP1, UP2 with decreasing slope (slope S4>slope S5>slope S6>slope S7=0 or slope S14>slope S15>slope S16>slope S17=0) towards the other vertex M2, M3; M1. The respective fluid-guiding surface 40 thus has, in this respect, a continuous progression and minimal slope (S1, S7; S11, S17), preferably zero, at the respective other vertex M2, M3; M1.

The fluid-guiding surface 40 is configured as a curve and the different gradients S2, S3, S4, S5, S6; S12, S13, S14, S15, S16 between the vertices M1, M2, M3 are formed by a transition at the reversal points UP1, UP2 from a concave to a convex curve progression. A plurality of pocket-like recesses 38 are arranged along the outer periphery 36 of the first control part 34 of the valve slide 16 such that the fluid-guiding surfaces 40 form a closed cosine curve progression between the individual vertices M1, M2, M3 along this outer periphery 36. At every third pocket-like recess 38, in the region of the vertex M1, a groove-like recess 50 connects to the bottom of the pocket-like recess 38. The largest opening cross section 52 of the respective pocket-like recess 38 is oriented to the fluid connection point 32 serving as the fluid outlet 54 of the valve housing 12. Owing to the groove-like recess 50, the control performance of the valve slide 16 is improved as a whole.

The valve slide 16 has a total of two control parts 34, 56, of which at least the first control part 34 has the pocket-like recesses 38 and the second control part 56 is arranged such that it is separated from the first control part 34 by a first fluid guide 58. The second control part 56 is shown in the non-actuated state of the valve slide 16, in other words at zero stroke in the left end position in the plane of the drawing, and in contact with an inner wall 62 of the housing by means of a cylinder-shaped guide part 60. The guide part 60 has a switching edge surface 64 extending in a step-like manner, which faces the first control part 34. The switching edge surface 64 is formed by a reduction 66 in diameter between the outer peripheral side 68 of the guide part 60 and a preferably conically extending transition part 70 of the valve slide 16 in the direction of the first control part 34. The conically extending transition part 70 forms a flow guide for the fluid flowing through the valve component 10 and effects a redirection of the fluid flow in the direction of the fluid outlet 54. It also contributes to flow force compensation. The transition part 70 can transition, either directly at the reduction 66 in diameter (FIG. 4) or via a reduction 66 in diameter in the form of a cut-out (FIG. 5), into the annular surface transverse to the longitudinal axis LA in the form of the switching edge surface 64, which abuts against the switching edge 72 at the outer peripheral side 68 of the cylinder-shaped guide part 60. The switching edge surface 64 is shifted downstream by the cut-out 66 in FIG. 5.

By means of a second guide part 74, the valve slide 16 is guided through the inner wall 62 of the valve housing 12 in the region of the connection point 32 serving as the fluid outlet 54 in the valve housing 12. A first fluid guide 58 is arranged between the first control part 34 and the second control part 56, holding them apart. A second fluid guide 76 between the second control part 56 and the second guide part 74 improves the flow dynamics of the valve slide 16 in the region of the second control part 56, thereby reducing the pressure losses inside the valve component 10. The second fluid guide 76 furthermore improves the sealing performance of the first guide part 60 with regard to the inner wall 62 of the housing, since the introduction of the second fluid guide 76 into the valve slide 16 enables the sealing gap between the valve slide 16 and the inner wall 62 of the housing to be reduced. The two fluid guides 58, 76, which form axial distances ASS, ASF between the first control part 34 and the second control part 56 as well as between the second control part 56 and the second guide part 74, are obtained by groove-like reductions 78, 80 in diameter in the valve slide 16. Such reductions 78, 80 in diameter are also designated as grooves.

The valve slide 16 rests with one of its free front surfaces 82 against an energy storage unit 84 in the form of a compression spring. Guides 86, 88 for the energy storage unit 84 are formed on the valve slide 16 and on the opposite cap screw 22. The valve slide 16 abuts with its other free front surface 90 against a volume space 92 of a variable volume, in which an inner channel 94 of the valve slide 16 opens with one of its ends 96; its other end 98 opening into the first fluid guide 58 between the two control parts 34, 56, directly adjacent to the transition part 70.

For reproducing the fluid pressure according to at least one pre-adjusted or adjustable measuring orifice 99 on one of the free front surfaces 82 of the valve slide 82, provision is made of a corresponding fluid channel 100 in the valve housing 12.

The graph of FIG. 6 shows the progression of the standard cross section over the opening stroke. The first guide part 60 is out of contact with the inner wall 62 of the housing after a defined opening stroke, hence the load holding function is overcome and fluid can flow from the fluid connection point 30, which forms the fluid inlet 102, to the fluid connection point 32, which forms the fluid outlet 54. Starting from this opening stroke, the standard cross section increases disproportionately with the increasing opening stroke up to a kink-free transition point, after which the standard cross section increases proportionately to the opening stroke. According to the invention the control accuracy and the stability are improved substantially by a standard cross section that increases monotonically and continuously over the opening stroke without kinks and with a very shallow initial slope.

Consequently, particularly advantages valve components 10 are illustrated by the invention. The pocket-like recesses 38 no longer open at an edge, but transition smoothly into the front surface 104 of the first control part 34. The advantage of this is that the standard cross section does not change abruptly at an edge. The progression of the standard cross section over the opening stroke therefore has no kink (see FIG. 6). As a consequence, the control accuracy of the valve components 10 is substantially higher and the stability of the control is likewise improved. On the second control part provision is made of a trailing edge 72, at which the flow surface transitions from an annular switching edge surface 64 extending in the radial plane into an outer peripheral surface 68 extending coaxially to the longitudinal axis LA of the valve slide 16. A load holding function is achieved in a particularly favourable manner by the switching edge surface 64 extending in a step-like manner. This prevents fluid from flowing against the normal flow direction from the fluid outlet 54 to the fluid inlet 102. Lastly, the additional fluid guide 76 advantageously improves the flow dynamics of the second control part 56 and facilitates the retraction of the valve slide 16. In addition, the sealing gap between the first guide part 60 and the inner wall 62 of the housing is reduced in an advantageous manner.

1. A valve component, conceived in particular as a pressure maintenance-type component, having a valve slide (16) which is movably guided in the longitudinal direction in a valve housing (12) and which has a control part (4) for controlling a fluid-conducting connection (28) between at least two fluid connection points (30, 32) accommodated in the valve housing (12), which control part has at least one pocket-like recess (38), at least part of which is bordered by a fluid-guiding surface (40) that runs between at least two vertices (M1, M2, M3) of the recess (38) and which has a slope that increases from one vertex (M1; M2, M3) to the other vertex (M2, M3; M1), characterized in that the fluid guiding surface (40), starting from a predeterminable distance (A1; A2) from the other vertex (M2, M3; M1), runs towards this other vertex (M2, M3; M1) with a slope (S4, S5, S6, S7; S14, S15, S16, S17) decreasing from its point of greatest slope (S4; S14).

2. The valve component as in claim 1, characterized in that the fluid-guiding surface (40) has a continuous progression and a minimal slope, preferably zero, at the respective other vertex (M1, M2, M3).

3. The valve component as in claim 1, characterized in that the fluid-guiding surface (40) is configured as a curve and that the different gradients between the vertices (M1, M2, M3) are formed by the transition from a concave to a convex curve progression.

4. The valve component as in claim 1, characterized in that a plurality of pocket-like recesses (38) are arranged along the outer periphery (36) of the control part (34) of the valve slide (16) such that the fluid-guiding surfaces (40) between the individual vertices (M1, M2, M3) form a closed sine or cosine curve progression along this outer periphery (36).

5. The valve component as in claim 1, characterized in that a groove-like recess (50) connects, at least in a portion of the pocket-like recesses (38), to the floor of the pocket-like recess (38) in the region of a vertex (M2).

6. The valve component as in claim 1, characterized in that the largest opening cross section (52) of the respective pocket-like recess (38) is oriented to the fluid connection point (32) that serves as the fluid outlet (54) of the valve housing (12).

7. A valve component, conceived in particular as a pressure maintenance-type component, having a valve slide (16) which is movably guided in the longitudinal direction in a valve housing (12) and which has two control parts (34, 56) for controlling a fluid-conducting connection (28) between at least two fluid connection points (30, 32) accommodated in the valve housing (12), of which at least one control point (34) has at least one pocket-like recess(38), wherein the other control point (56), in the non-actuated state (UZ), is in contact by means of a guide part (60) with an inner wall (62) of the housing along which the valve slide (16) is movably guided, characterized in that the guide part (60) has a switching edge surface (64) extending in a step-like manner, which faces the first control part (34).

8. The valve component as in claim 7, characterized in that the switching edge surface (64) extending in a step-like manner in the guide part (60) of the second control part (56) is formed by a reduction (66) in diameter between the outer peripheral side (68) of the guide part (60) and a preferably conically extending transition part (70) of the valve slide (16) in the direction of the first control part (34).

9. A valve component, conceived in particular as a pressure maintenance-type component, having a valve slide (16) which is guided in the longitudinal direction in a valve housing (12) and which has a first control part (34) and a second control part (56) for controlling a fluid-conducting connection (28) between at least two fluid connection points (30, 32) accommodated in the valve housing (12), wherein the second control part (56) is in contact by means of a guide part (60) with an inner wall (62) of the housing along which the valve slide (16) is movably guided, wherein in the region of the fluid connection point (32) serving as the fluid outlet (54) in the valve housing (16), the valve slide (16) is guided through the inner wall (62) thereof by means of another guide part (74) and wherein a fluid guide (58) is arranged between the first control part (34) and the second control part (56), holding these control parts (34, 56) at a distance (ASF), characterized in that another fluid guide (76) is present, which holds the second control part (56) at a distance (ASF) from the second guide part (74).

10. The valve component as in claim 9, characterized in that the two fluid guides (58; 76) forming axial distances (ASS; ASF) between the first control part (34) and the second control part (56) as well as between the second control part (56) and second guide part (74) are obtained by groove-like circumferential reductions (78, 80) in diameter in the valve slide (16).

11. The valve component as in claim 9, characterized in that the valve slide (16) rests with one of its free front surfaces (82) against an energy storage unit (84) and abuts with its other free front surface (90) against a volume space (92) of variable volume, into which an inner channel (94) of the valve slide (16) opens with one of its ends (96); the other end (98) of which is fluidically connected to the fluid guide (58) between the two control parts (34, 56).
